(19) United States
(12) Patent Application Publication
(10) Pub. No.: US 2003/0200094 A1
(43) Pub. Date: Oct. 23, 2003

(54) System and method of using existing knowledge to rapidly train automatic speech recognizers

(76) Inventors: Narendra K. Gupta, Dayton, NJ (US); Mazin G. Rahim, Matawan, NJ (US); Giuseppe Riccardi, Hoboken, NJ (US)

Correspondence Address: AT&T CORP., P.O. BOX 4110, MIDDLETOWN, NJ, 07748, US

(21) Appl. No.: 10/326,691

(22) Filed: Dec. 19, 2002

Related U.S. Application Data
(60) Provisional application No. 60/374,961, filed on Apr. 23, 2002.

(51) Int. Cl. G10L 21/00

(52) U.S. Cl. 704/270.1

(57) ABSTRACT

A method of rapidly training an automatic speech recognizer as part of a spoken dialog system for an enterprise includes extracting information from enterprise emails, web site content, and/or speech or data records of interactions between customers and the enterprise. The method comprises extracting the relevant data to develop a domain-specific language model, generating an acoustic model from non-domain-specific data, combining the domain-specific language model with the non-domain-specific acoustic model to initially deploy the spoken dialog service, and adapting the language models as task-specific data becomes available.

### RELATED APPLICATIONS

This case is related to Attorney Docket No. 2002-0093, Attorney Docket No. 2002-0093A, and Attorney Docket No. 2002-0050. Each of these patent applications is filed on the same day as the present application, assigned to the assignee of the present application, and incorporated herein by reference. This case is further related to U.S. Provisional Patent Application No. 60,374,961, filed Apr. 23, 2002, and U.S. patent application Ser. No. 10/160,461, filed May 31, 2002. Each of these related filed patent applications is assigned to the assignee of the present application and is incorporated herein by reference.

### BACKGROUND OF THE INVENTION

1. Field of the Invention

The present invention relates to automatic speech recognizers and more specifically to a system and method of using data for bootstrapping automatic speech recognizers for spoken dialog systems.

2. Discussion of Related Art

Spoken dialog systems provide individuals and companies with a cost-effective means of communicating with customers. For example, a spoken dialog system can be deployed as part of a telephone service that enables users to call in and talk with the computer system to receiving billing information or other telephone service-related information. In order for the computer system to understand the words spoken by the user, a process of generating data and training recognition grammars is necessary. The resulting grammars generated from the training process enable the spoken dialog system to accurately recognize words spoken within the “domain” that it expects. For example, the telephone service spoken dialog system will expect questions and inquiries about subject matter associated with the user's phone service.

Spoken dialog systems include general components known to those of skill in the art. These components are illustrated in FIG. 1. The spoken dialog system 100 may operate on a single computing device or on a distributed computer network. The system 100 receives speech sounds from a user 112 and operates to generate a response. The general components of such as system include an automatic speech recognition (“ASR”) module 102 that recognizes the words spoken by the user 112. A spoken language understanding (“SLU”) module 104 associates a meaning to the words received from the ASR 102. A Dialog Management (“DM”) module 106 manages the dialog by determining an appropriate response to the customer question. Based on the determined action, a language generation (“LG”) module 108 generates the appropriate words to be spoken by the system in response and a Text-to-Speech (“TTS”) module 110 synthesizes the speech for the user 112. The DM module 106 may also incorporate and handle the language generation function.

Natural language dialog applications may be generated for a company's specific purpose. For the ASR module 102 to recognize speech from the user 112 at an acceptable error rate, the expected questions from the user must be in a narrow and expected category and type. For example, an application that deals with telephone service billing questions will expect questions from users related to telephone billing.

A training phase in the development of a spoken dialog system is required to enable the ASR module 102 to increase its recognition error rate to acceptable levels. Training involves practice with users interacting with the system to develop a database of experience from which to make recognition decisions. This process is known in the art. Once training is complete, the ASR module 102 error rate will be acceptable and the application can be deployed to service the company. Currently, training takes about six months to complete.

The difficulty with the training component of deploying a spoken dialog system is that the cost and time required precludes smaller companies from purchasing the service or even exploring the deployment of a natural voice dialog service. Larger companies may be hindered from employing such a service because of the delay required to prepare the system. What is needed in the art is a method of rapidly deploying a spoken dialog system.

### SUMMARY OF THE INVENTION

The present invention addresses the deficiencies in the prior art by introducing algorithms for bootstrapping the training process from data already held by the company. For example, emails, web content, records of user conversations with services departments, and any other interactive data between users (customers) and an entity such as a business all provide information about the company, but this data has previously been overlooked or considered useless in the process of deploying a spoken dialog system.

The present invention may enable an entity to provide services such as call routing, information access for customers with direct questions and answers being handled by a spoken dialog system; and problem solving in such areas as software installation.

One embodiment of the invention relates to a method of using data for preparing a spoken dialog system for an enterprise, the method comprises extracting relevant data associated with the enterprise, training grammars by combining stochastic models from the relevant data, and associating the trained grammars with an automatic speech recognizer for the spoken dialog system. The relevant data comprises, for example, web site data, email data and recycled speech and language data. Relevant data may be obtained from “recycled data” when web site data and email data are used to generate an information retrieval engine that filters and extracts relevant data from such data as human/machine interactions and text corpora. Since email and web data reflect content and phrases of higher importance, such “recycled” data increases the rapid deployment of the spoken dialog system.

An aspect of the invention comprises training grammars by combining the stochastic models from the data sources described above. The resulting language models are associated with the automatic speech recognizer in a spoken dialog system.

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

### BRIEF DESCRIPTION OF THE DRAWINGS

The foregoing advantages of the present invention will be apparent from the following detailed description of several embodiments of the invention with reference to the corresponding accompanying drawings, in which:

FIG. 1 illustrates the components of a prior art spoken dialog system;

FIG. 2 illustrates the components associated with an embodiment of the invention;

FIG. 3 illustrates examples of the sources of data for preparing domain-specific spoken dialog models;

FIG. 4 illustrates an exemplary process of obtaining data from emails in preparation of training an automatic speech recognition system; and

FIG. 5 illustrates an exemplary method of bootstrapping a spoken language dialog system.

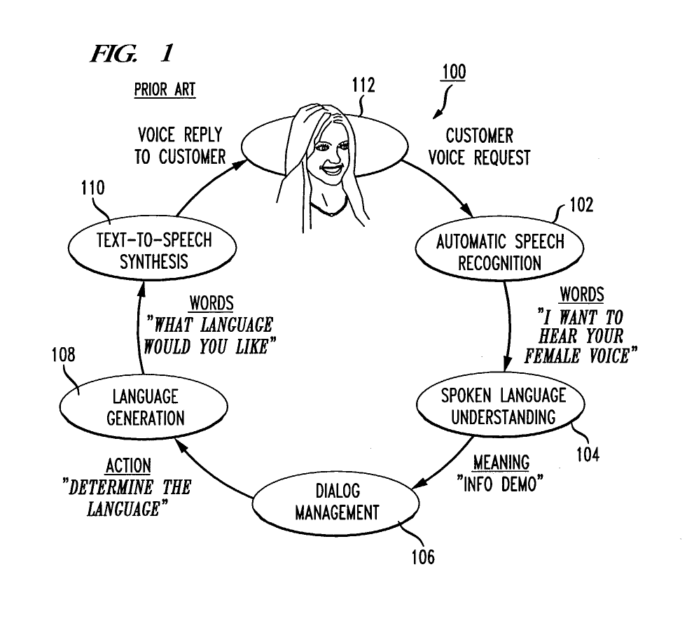

### DETAILED DESCRIPTION OF THE INVENTION

The present invention relates to improved tools, infrastructure and processes for rapidly prototyping a natural language dialog service. Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices. As will become clear in the description below, the physical location where various steps in the methods occur is irrelevant to the substance of the invention disclosed herein. The important aspect of the invention relates to the method of using existing data associated with an enterprise, such as a company, to rapidly deploy a spoken dialog system having acceptable accuracy rates for the domain of information and conversation associated with the enterprise. Accordingly, as used herein, the term “the system” will refer to any computer device or devices that are programmed to function and process the steps of the method.

Another aspect of the invention is a spoken dialog system generated according to the method disclosed herein. While the components of such a system will be described, the physical location of the various components may reside on a single computing device, or on various computing devices communicating through a wireline or wireless communication means. Computing devices continually improve and those of skill in the art will readily understand the types and configurations of computing devices upon which the spoken dialog system created according to the present invention will operate.

The overall function of the spoken dialog system, or help desk, is to provide a company with a telephone service that operates twenty-four hours a day that can handle call routing issues such as routing calls to sales departments or technical support. For example, the help desk provides automated information through natural voices to customers in such areas as providing demonstrations of services or products and pricing information. Answers to general questions such as “Does your software run on Linux?” require complex processing to understand and to generate an appropriate and correct response. Other uses of a help desk may include providing services such as assistance in software installation or constructing a piece of furniture or a bicycle.

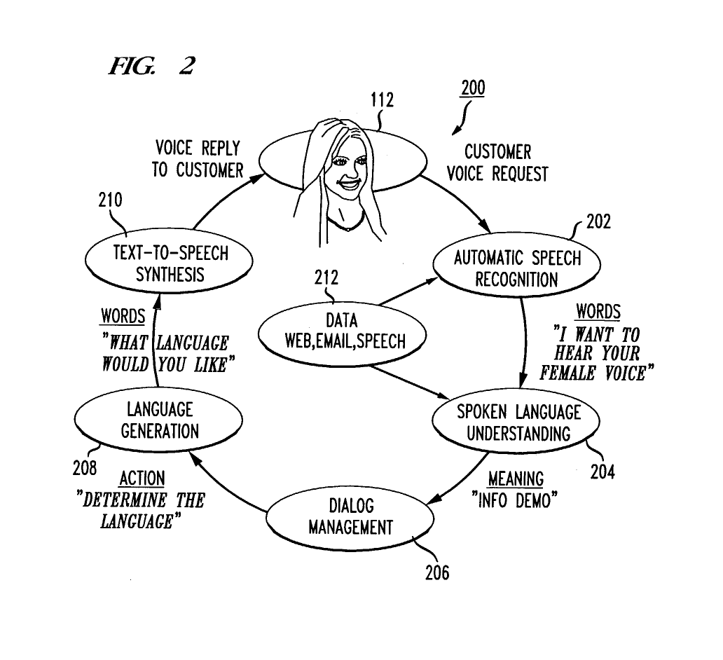

FIG. 2 illustrates the components of a spoken dialog system 200 according to an aspect of the present invention. The system 200 receives speech sounds from a user 112 and operates to generate a response. The general components of the system 200 comprise an automatic speech recognition (“ASR”) module 202 that recognizes the words spoken by the user 112. A spoken language understanding (“SLU”) module 204 associates a meaning to the words received from the ASR 202. For example, the phrase “I want to hear your female voice” may result in that text being passed to the SLU wherein it determines that info_demo is the category of information desired. In a spoken dialog system, such categories may include, for example, the following: info_demo, language, sales_agent, custom, info_general, info_agent, tech_voice, tech_agent, sales_sdk, info pricing, and/or discourse help. The co-pending patent applications incorporated above provide further detail regarding the SLU module and its classification of utterances. A Dialog Management (“DM”) module 206 manages the dialog by determining an appropriate response to the customer question. Based on the determined action, a language generation (“LG”) module 208 generates the appropriate words to be spoken by the system in response and a Text-to-Speech (“TTS”) module 210 synthesizes the speech for the user 112.

The present invention relates to an additional element of using existing data 212 such as, for example, a company's emails, web site content, or speech data—to rapidly train and create grammars for primarily the ASR module 202 and, in some respects, SLU module 204. The patent application Ser. No. 10/160,461 incorporated above, focuses on the SLU module and incorporates prior knowledge in order to more rapidly enable the SLU module when a dearth of initial training data exists. The present application focuses more on the ASR module 202. The content or data used according to the present invention typically is existing data already held by the enterprise. The method of bootstrapping a spoken dialog system from enterprise data, however, is not limited to pre-existing data but may also include additional data—for example, emails exchanged in preparation for the bootstrapping effort—which is added to the existing data for the purpose of generating the spoken dialog service.

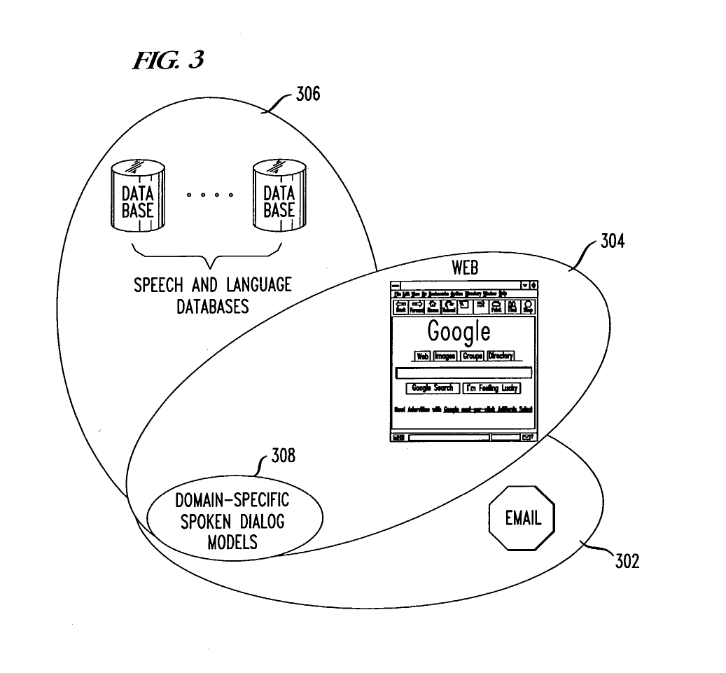

FIG. 3 illustrates several example sources of data for creating domain-specific spoken dialog models 308. To illustrate this aspect of the invention, an example process will be described. Assume that a company that provides on-line book sales desires to incorporate a help desk service to their company offerings. The data already existing that is associated with the on-line company includes emails 302 to and from their customer service and technical service department or other departments, the company web site content 304 that includes data and book reviews for individual books and other data, as well as speech and language databases 306 from telephone conversations with customers who use the call-in number. Other sources of company data may also be available that do not fall into these exemplary categories. As illustrated in FIG. 3, these different sources of data all relate to the same “domain,” namely the on-line enterprise, and thus each overlap the Domain-Specific Spoken Dialog Model 308. Typically, when the company desires to begin the process of developing a spoken dialog service or help desk, data in each of these areas already exists in some form.

Examples of content from a web site versus emails versus spontaneous speech may be illustrated by examples of each. Text from an on-line book retailer web site may include such phrases as “Lower prices! Save 30% or more on books over $20, unless clearly marked otherwise” or “See the New Top Ten Best Seller Book List!” or “The AT&T Labs Natural Voices Text-to-Speech (ffS) Engine is the tool for generating voice interfaces for users.” Email interactions with users may include phrases like “I want to buy the last book of the Lord of the Rings” or “When will the soft-cover version of The Firm be released?” Examples of a human-machine interaction may include a question and answer, such as: Computer Device: “Hi, you're listening to AT&T Natural Voices Text-to-Speech, How may I help you?” The user may answer: “Umm, I'd like to hear a demo.” These are several examples of the existing data from which the help desk will be bootstrapped.

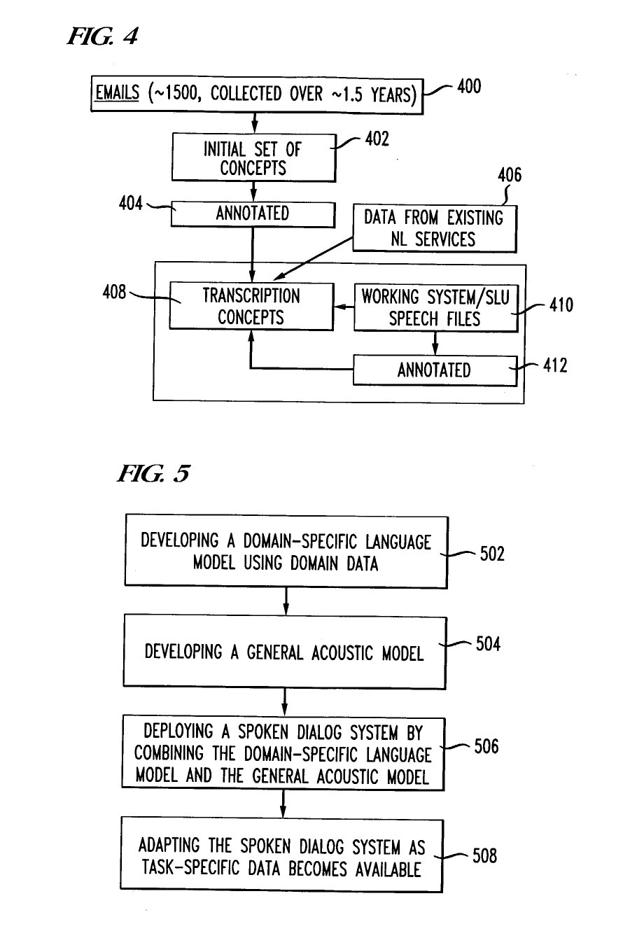

Since the style, sentence length distribution and content words may differ depending on the source of the existing data, different approaches are employed for using email, web, and speech data for rapid deployment of a spoken dialog system. FIG. 4 illustrates the method of drawing upon a collection of emails 400 associated with a company. The initial set of concepts 402 contained with the emails is annotated 404. Data from existing natural language (NL) services 406 are used and combined to provide transcription concepts 408. For example, the data from existing NL services may include data from a phone service NL database that could be applied or used for developing a spoken dialog system for the on-line book retailer. An advantage of using existing NL services data although the data is non-domain-specific is that speech patterns and spontaneous speech may relate to the particular domain for which the service is being developed.

From the transcription concepts, the system iterates with a working system and spoken language understanding (SLU) module with speech files 410 to obtain further annotations 412 to revise the transcription concepts 408. In this regard, the invention enables a bootstrapping approach for initial deployment of a spoken dialog system and an adaptation approach as task-specific data becomes available. This is accomplished by using a general-purpose subword-based acoustic model (or a set of specialized acoustic models combined together, and a domain-specific stochastic language model (or a set of specialized language models). For the acoustic model, the ASR engine according to the present invention uses a general-purpose context-dependent hidden Markov model. This model is then adapted using Maximum a posteriori adaptation once the system is deployed and live task-specific data is developed. See, e.g., Huang, Acero and Hon, Spoken Language Processing, Prentice Hall PTR (2001), pages 445-447 for more information regarding Maximum a posteriori adaptation.

When generating the ASR module 202, stochastic language models are preferred for providing the highest possibility of recognizing word sequences “said” by the user 112. The design of a stochastic language model is highly sensitive to the nature of the input language and the number of dialog contexts or prompts. A stochastic language module takes a probabilistic viewpoint of language modeling. See, e.g., Id., pages 554-560. One of the major advantages of using stochastic language models is that they are trained from a sample distribution that mirrors the language patterns and usage in a domain-specific language. They do, however, require a large corpus of data when bootstrapping.

Task-specific language models tend to have biased statistics on content words or phrases and language style will vary according to the type of human-machine interaction (i.e., system-initiated vs. mixed initiative). While there are no universal statistics to search for, the invention seeks to converge to the task-dependent statistics. This is accomplished by using different sources of data to achieve fast bootstrapping of language models including language corpus drawn from, for example, domain-specific web sites, language corpus drawn from emails (task-specific), and language corpus drawn a spoken dialog corpus (non-task-specific).

The first two sources of data (web sites and emails) can give a rough estimate of the topics related to the task. However the nature of the web and email data do not account for the spontaneous speech speaking style. On the other hand, the third source of data can be a large collection of spoken dialog transcriptions from other dialog applications. In this case, although the corpus topics may not be relevant, the speaking style may be closer to the target help desk applications. The statistics of these different sources of data are combined via a mixture model paradigm to form an n-gram language model. See, e.g., Id., pages 558-560. These models are adapted once task-specific data becomes available.

An exemplary method of bootstrapping the ASR module 202 and dialog grammars comprises the following. For the ASR module 202, preferably, an acoustic model such as an 0300 AM model may be used. The example three sources of data are used for training the language models. Depending on the size of the data available, simple unigram or higher order phrase n-grams may be used. See, e.g., Id., pages 558560 for more information on n-gram stochastic language modeling.

For the language models for the dialog manager 206, preferably stochastic language models are used and four dialog contexts are employed, including generic, confirmation, language and help. The language models are trained for these four contexts as logical and/or combinations of the four base grammars.

FIG. 5 illustrates a process for rapidly prototyping a natural language dialog service. First, the system extracts domain-specific language associated with the enterprise (502). This data may involve emails, voice recordings with customers, web site data and information, or other data associated with the enterprise. For example, for web site data, the data is extracted using generally known techniques of filtering after which the data is parsed into utterances. An example of web site data includes: “The AT&T Natural Voices Text-to-Speech (TTS) Engine is the tools for giving voice . . . ” and “Interested in purchasing AT&T Labs Natural Voices Products? Visit the ‘How to Buy’ section of this web site.”

For emails, a filter is applied to segment and parse email data into utterances. Only utterances relevant to the task or tasks associated with the natural language dialog services are extracted. For example, emails may include the following language: “what kind of product is available eg sdk” or “I'm curious to find out how this product will be released in its final form.”

“Recycled” data is then extracted. Based on the email and website data, an information retrieval engine is constructed to search through a bank of human/machine dialogs and text corpora. From the already recorded database of human interaction, the following example dialog may exist: System: “Hi, you are listening to AT&T Natural Voices text to speech . . . how can I help you?”, User: “Uh, I think I'd like to hear a demo.” In this manner, naturally spoken and language utterances that are associated with the desired tasks may be extracted from the language databases. The content words are drawn from the web and email data, while the natural language and spoken words are drawn from the recycled data. A domain-specific language model is developed using the domain-specific data.

While the domain-specific data discussed above provides content words and text, it does not account for spontaneous speech patterns and speaking style. In this regard, spoken dialog data drawn from other sources that may not be domain-specific can be used. For example, if one business selling appliances is developing a spoken dialog service, the domain-specific data can be drawn from its web-site and emails, while the spoken dialog corpus, for the initial deployment of the service, can be drawn from a non-domain-specific dialog corpus that will likely share speaking patterns. Developing a general acoustic model (504) comprises using non-domain-specific dialog data to generate the general-purpose subword-based acoustic model or a set of specialized acoustic models combined together.

The next step relates to the initial deployment of the spoken dialog system and comprises deploying the dialog system by combining the domain-specific language model and the general acoustic model (506). A mixture model paradigm combines the domain-specific data with the non-domain-specific spoken dialog corpus to form the initial language model, such as an n-gram language model. Once the service is initially deployed, as people use the service, task-specific data is gathered. The language model is then adapted with task-specific data as people use the spoken dialog service (508).

The main focus of this invention is to address the issue of bootstrapping the ASR models for a new goal-oriented natural language dialog system such that data from different sources may be mined to build and adapt a new language model for ASR.

Although the above description may contain specific details, they should not be construed as limiting the claims in any way. Other configurations of the described embodiments of the invention are part of the scope of this invention. For example, other sources of enterprise information may exist beyond those discussed above. Bootstrapping a natural language spoken dialog service using a variety of sources of bootstrapping data beyond those mentioned is within the scope of the appended claims. Accordingly, the appended claims and their legal equivalents should only define the invention, rather than any specific examples given.

We claim:

1. A method of using enterprise data for preparing an automatic speech recognition module for a spoken dialog service for the enterprise, the method comprising:
extracting relevant existing data associated with the enterprise;
training grammars by combining stochastic models from the relevant existing data; and
associating the trained grammars with an automatic speech recognizer for the spoken dialog service.

2. The method of using enterprise data for preparing an automatic speech recognition module for a spoken dialog service of claim 1, wherein the relevant existing data is email data.

3. The method of using enterprise data for preparing an automatic speech recognition module for a spoken dialog service of claim 1, wherein the relevant existing data is web-based data.

4. The method of using enterprise data for preparing an automatic speech recognition module for a spoken dialog service of claim 1, wherein the relevant existing data is recycled data.

5. The method of using enterprise data for preparing an automatic speech recognition module for a spoken dialog service of claim 1, wherein extracting relevant existing data associated with the enterprise further comprises applying a filter to the relevant existing data.

6. The method of using enterprise data for preparing an automatic speech recognition module for a spoken dialog service of claim 5, further comprising parsing the filtered data into utterances.

7. The method of using enterprise data for preparing an automatic speech recognition module for a spoken dialog service of claim 1, wherein the spoken dialog service is associated with a particular task.

8. The method of using enterprise data for preparing an automatic speech recognition module for a spoken dialog service of claim 7, wherein extracting relevant data further comprises extracting data associated with the particular task.

9. A method of using information for rapidly training an automatic speech recognizer, the method comprising:
extracting relevant existing data from a web site associated with an enterprise;
based on the extracted web site data, constructing an information retrieval engine to extract data related to the enterprise from non-web site databases; and
training grammars for the automatic speech recognizer using the relevant existing data.

10. The method of claim 9, further comprising, before constructing the information retrieval engine:
extracting relevant existing data from emails associated with the enterprise, wherein the email-associated data and the web site data are both used to construct the information retrieval engine.

11. A method of using information for rapidly training an automatic speech recognizer, the method comprising:
extracting relevant existing data from emails associated with an enterprise;
based on the extracted email data, constructing an information retrieval engine to extract data related to the enterprise from non-web-site databases; and
training grammars for the automatic speech recognizer using the relevant existing data.

12. An automatic speech recognition module for use in a spoken language dialog service for an enterprise, the automatic speech recognition module generated according to the steps of:
extracting relevant existing data associated with the enterprise;
training grammars by combining stochastic models from the relevant existing data; and
associating the trained grammars with an automatic speech recognizer for the spoken dialog service.

13. The automatic speech recognition module of claim 12, wherein the relevant existing data is email data.

14. The automatic speech recognition module of claim 12, wherein the relevant existing data is web-based data.

15. The automatic speech recognition module of claim 12, wherein the relevant existing data is recycled data.

16. The automatic speech recognition module of claim 12, wherein extracting relevant existing data associated with the enterprise further comprises applying a filter to the relevant existing data.

17. The automatic speech recognition module of claim 16, wherein the filtered data is parsed into utterances.

18. The automatic speech recognition module of claim 12, wherein the spoken dialog service is associated with a particular task.

19. The automatic speech recognition module of claim 18, wherein extracting relevant existing data further comprises extracting data associated with the particular task.

20. A method of collecting data for preparing an automatic speech recognition module for a spoken dialog service associated with a particular task associated with an enterprise, the method comprising:
extracting data relevant to the particular task from data previously stored by the enterprise;
training grammars by combining stochastic models from the relevant data; and
associating the trained grammars with an automatic speech recognizer for the spoken dialog service.

21. An automatic speech recognition module within a spoken dialog service trained according to a method of using enterprise data for preparing a spoken dialog service for the enterprise, the method comprising:
extracting relevant data associated with the enterprise;
training grammars by combining stochastic models from the relevant data; and
associating the trained grammars with an automatic speech recognizer for the spoken dialog service.

22. An automatic speech recognition module for use in a spoken language dialog service for an enterprise, the automatic speech recognition module comprising:
a general-purpose acoustic model generated from non-domain-specific data; and
a domain-specific language model, wherein upon initial deployment of the spoken dialog service, the general-purpose acoustic model and the domain-specific language model are combined to form a deployed language model.

23. The automatic speech recognition module of claim 22, wherein after initial deployment of the spoken dialog service, the deployed language model is adapted using task-specific data gathered from the deployed spoken dialog service.

24. A method of using enterprise data for generating an automatic speech recognition module for a spoken dialog service for the enterprise, the method comprising:
developing a domain-specific language model using domain-specific data;
developing a general acoustic model using non-domain-specific data; and
combining the domain-specific language model and the general acoustic model to generate a deployed language model for initially deploying the spoken dialog service.

25. The method of using enterprise data for generating an automatic speech recognition module of claim 24, further comprising:
after initial deployment of the spoken dialog service, adapting the deployed language model using task-specific data that becomes available.

26. The method of using enterprise data for generating an automatic speech recognition module for a spoken dialog service of claim 24, wherein the domain-specific data is email data.

27. The method of using enterprise data for generating an automatic speech recognition module for a spoken dialog service of claim 24, wherein the domain-specific data is web-based data.

28. The method of using enterprise data for generating an automatic speech recognition module for a spoken dialog service of claim 24, wherein the non-domain-specific data is dialog data associated with speech patterns similar to those in the domain.

29. A TTS spoken dialog service for a domain, the spoken dialog service generated according to the steps of
developing a general purpose acoustic model using non-domain-specific data; and
developing a domain-specific language model, wherein upon initial deployment of the spoken dialog service, the general-purpose acoustic model and the domain-specific language model are combined to form a deployed language model.

30. The TTS spoken dialog service of claim 29, wherein after initial deployment of the spoken dialog service, the deployed language model is adapted using task-specific data gathered from the deployed spoken dialog service.

31. The TTS spoken dialog service of claim 30, wherein the domain-specific data is email data.

32. The TTS spoken dialog service of claim 31, wherein the domain-specific data is web-based data.

33. The TTS spoken dialog service of claim 29, wherein the non-domain-specific data is dialog data associated with speech patterns similar to those in the domain.

34. A spoken dialog service trained according to a method of using enterprise data for preparing a spoken dialog service for the enterprise, the method comprising:
extracting relevant data associated with the enterprise;
training grammars by combining stochastic models from the relevant data; and
associating the trained grammars with an automatic speech recognizer for the spoken dialog service.

35. The spoken dialog service of claim 34, wherein the relevant data associated with the enterprise comprises web-site data.

36. The spoken dialog service of claim 35, wherein the relevant data associated with the enterprise further comprises email data.

37. The spoken dialog service of claim 36, wherein the relevant data associated with the enterprise further comprises a spoken dialog corpus.
